(19) United States
(12) Patent Application Publication
(10) Pub. No.: US 2010/0260006 A1
(43) Pub. Date: Oct. 14, 2010

(54) COOLING DEVICE FOR HIGH PRESSURE HOMOGENIZING APPARATUS

(76) Inventors: Shigeo Ando, Chiba (JP); Masao Ando, Chiba (JP); Toyoroku Ando, Chiba (JP)

Correspondence Address: KRATZ, QUINTOS & HANSON, LLP, 1420 K Street, N.W., 4th Floor, WASHINGTON, DC, 20005, US

(21) Appl. No.: 12/744,212

(22) PCT Filed: Nov. 12, 2008
(86) PCT No.: PCT/JP2008/070601

§ 371 Date: May 21, 2010

(30) Foreign Application Priority Data
Nov. 30, 2007 (JP) 2007-309924

(51) Int. Cl. B01F 15/06

(52) U.S. Cl. 366/149

(57) ABSTRACT

A suspension contains a base material including a fine solid matter. The base material may be in the form of a semifluid matter. The base material is compressed with a high pressure. The compressed base material is passed through an orifice at a high speed. The orifice includes a small clearance defined between (a) the end of the movable valve provided slidably and rotatably in the length direction inside of the cylinder case and (b) the opposing wall surface of the cylinder case. For dispersion, to emulsification, crushing, and subdivision of the base material, there is provided a heat exchange unit including continuous conduits through which a cooling medium can flow, the conduits extending over a desired length in the length direction about the orifice as a source of heat.

### TECHNICAL FIELD

The present invention relates generally to a cooling device for a high pressure homogenizing apparatus that compresses with high pressure a suspension containing a fine base material or the base material in the form of such a suspension for use in foods, seasonings, beverages, chemical products, medical products, cosmetics, and various types of resins, makes the base material pass through an orifice at a high speed for dispersion, emulsification, crushing, and/or subdivision of the base material, and relates in particular to the cooling device that cools the heat-producing orifice as a source of heat of the high pressure homogenizing apparatus, ensures an appropriate degree of a small clearance in the orifice in order for the high pressure homogenizing apparatus to be capable of operating over an extended period of time.

### BACKGROUND ART

In areas of industries such as paper industry, a high-pressure homogenizing apparatus is known that disperses and subdivides a base material contained in a suspension, the base material including fiber cellulose, through making the suspension pass through a small-diameter orifice at high speed and under high pressure (for example, see the patent literature PTL 1: Japanese Patent Application Laid-Open Publication No. S60-19921).

### SUMMARY OF THE INVENTION

### Problem to be Solved by the Invention

In the conventional high-pressure homogenizing apparatus of PTL 1, the suspension including fiber cellulose as the base material is subjected to high pressure and passed through the small-diameter orifice defined radially of the apparatus and between corresponding surfaces of a valve seat and a valve body, so that the base material is subdivided under high pressure difference. The valve is pressed against the valve seat by a driving force of a cylinder having a piston, or by spring biasing force of a spring, so that an internal pressure is adjusted.

This configuration makes it difficult to provide the orifice having a small clearance, which in turn makes it difficult to subdivide with accuracy the base material as the orifice suffers clogging. If the orifice clearance is too small, the orifice is more likely to be clogged with the base material contained in the suspension, which understandably hinders subdivision operation. If the orifice clearance is too large, the base material is easily passed through the orifice, which understandably hinders accurate subdivision of the base material. As a result, the accurate subdivision of the base material fails to be achieved.

The orifice having the small clearance may be clogged on account of viscosity of the suspensions, and such a clogged orifice hinders conduit of the base material therethrough, making it difficult to subdivide the base material. Also, the high-pressure homogenizing apparatus with the clogged orifice will have to be disassembled to clean up an inside thereof. In addition, the disassembled homogenizer will have to be reassembled. In such circumstances, maintenance of the homogenizing apparatus cannot be simplified.

In dispersion, emulsification, crushing, and subdivision of the base material under high pressure difference in the same high pressure homogenizing apparatus, heat is produced as the base material compressed with high pressure is passed through the small-clearance orifice with high speed. Due to this heating, the orifice components including a cylinder case and a movable valve slidable in the cylinder case may be expanded through thermal conduction. As a result, the small clearance of the orifice defined between an end of the movable valve rotatably and slidably provided in the cylinder case in a length direction thereof and an opposing wall surface of the cylinder case may be restricted due to the expansion.

This means that it is difficult to ensure an appropriate degree of the small clearance of the orifice. Also, as has been discussed in the foregoing, operation of the subdivision of the base material cannot be accurately performed. In other words, the orifice becomes more likely to be clogged with the base material, making it difficult for the base material to be passed through the orifice, causing hindrance to the subdivision of the base material to the detriment of highly accurate subdivision operation.

The orifice having the small clearance may be clogged on account of viscosity of the suspensions, and such a clogged orifice hinders conduit of the base material therethrough, making it difficult to subdivide the base material. Also, the high-pressure homogenizing apparatus with the clogged orifice will have to be disassembled to clean up an inside thereof. In addition, the disassembled homogenizer will have to be reassembled. In such circumstances, maintenance of the homogenizing apparatus cannot be simplified.

In view of the above-identified drawbacks, it is an object of the present invention to provide a cooling device for the high pressure homogenizing apparatus that is capable of defining an appropriate degree of the orifice clearance, free from inadvertent leakage of the base material or clogging of the orifice with the base material, allowing high accuracy and efficiency in the subdivision of the base material, with more simplified configuration and less wearing of or damage to the components, allowing long mechanical service life and improved ease of cleaning and maintenance.

### Means for Solving the Problem

In order to solve the above-identified problem, according to a first aspect of the present invention, there is provided a cooling device for a high pressure homogenizing apparatus for compressing with high pressure a suspension containing a fine base material or the base material in the form of a semifluid matter, making the compressed base material pass through an orifice at high speed, the orifice having a small clearance defined between (a) an end of a movable valve operable to be slid and rotated inside of a cylinder case in a length direction thereof and (b) an opposing wall surface of the cylinder case, and for performing dispersion, emulsification, crushing, and subdivision of the base material under a high pressure difference, characterized in that the cylinder case includes a heat exchange unit having conduits continuously provided over a desired length in the length direction of the cylinder case, the conduits being constructed to let a cooling medium pass therethrough, and the conduits extending about the orifice such that the orifice as a source of heat is surrounded by the conduits in the length direction.

The present invention according to a second aspect of the present invention is the cooling device of the high pressure homogenizing apparatus according to the first aspect, wherein the heat exchange unit is provided inside of the cylinder case such that the conduits of the heat exchange unit meanderingly extend concentrically in its cross section or such that the conduit extend spirally.

Also, the present invention according to a third aspect thereof is the cooling device of the high pressure homogenizing apparatus according to the first aspect, wherein the heat exchange unit meanderingly extends in an exterior body attached to an external surface of the cylinder case and cross-sectionally concentrically or spirally.

Also, the present invention according to a fourth aspect thereof is the cooling device of the high pressure homogenizing apparatus according to any of the first to third aspects, wherein the heat exchange unit is either provided in at least one cylinder block body out of a plurality of cylinder block bodies constituting the cylinder case, the at least one block body being carried by an internal pressure adjustment valve installation section within which the orifice is defined, or provided in an exterior body attached to an external surface of the cylinder block body.

The present invention according to a fifth aspect thereof is the cooling device according to any one of the first to fourth aspects of the present invention, wherein the cooling medium is selected from tap water, oil, gas, cooled tap water, cooled oil, or cooled gas.

The present invention according to a sixth aspect thereof is the device according to any one of the first to fifth aspects thereof, wherein the cooling medium is let to flow into the meandering conduits from a lower side of the cylinder case, passed through the meandering conduits toward an upper side of the cylinder case, and then exited from the meandering conduits.

The present invention according to a seventh aspect thereof is the device according to any one of the first to sixth aspects of the present invention, wherein the orifice has a small clearance between 1/100 millimeters and 1/200 millimeters.

The present invention according to an eighth aspect thereof is the device according to any one of the first to seventh aspect thereof, wherein the suspension containing the base material or the base material in the form of a semifluid matter is prepared such that the suspension or the semifluid matter has an internal pressure between 100 MPa and 280 MPa.

### EFFECTS OF THE INVENTION

According to the first aspect of the present invention, the cooling device for the high pressure homogenizing apparatus is constructed to compress the suspension or the fine base material with high pressure (the suspension contains the base material and the base material is in the form of the semifluid matter), let the compressed base material pass through the orifice at high speed, the orifice having a small clearance defined between (a) the end of the movable valve that is slidable inside of the cylinder case and rotatable in the length direction of the cylinder case and (b) the opposing wall surface of the cylinder case, and perform dispersion, emulsification, crushing, and subdivision of the base material with the high pressure difference. The cooling device is characterized in that the cylinder case includes the heat exchange unit having conduits continuously provided over the desired length in the length direction of the cylinder case, the conduits constructed to let the cooling medium pass therethrough, and the conduits extending about the orifice such that the orifice as the source of heat is surrounded by the conduits in the length direction.

The heat is produced as the high-pressure compressed base material is passed through the orifice having the small clearance at high speed, and the dispersion, emulsification, crushing, and subdivision of the base material is performed with the high pressure difference. The heat is placed under heat exchange through the cooling medium passing through the continuous conduits over the desired length in the cylinder case in the length direction thereof, the orifice as the source of heat being center around which the conduits extend. The cylinder case and the orifice components such as the movable valve provided slidably inside of the cylinder case are prevented from being expanded due to thermal conduction caused by the heat produced by the orifice, by virtue of cooling effect by the cooling medium flowing through the conduits of the cooling device extending about the heat-source orifice as the central axis.

Accordingly, the small clearance of the orifice, which is defined between (a) the end of the movable valve provided inside of the cylinder case and (b) the opposing wall surface of the cylinder case, can be maintained in an appropriate degree. The base material can be efficiently subdivided. The operation can be more accurately performed. The base material can be passed thorough the orifice without the orifice getting clogged with the base material. The subdivision of the base material is not hindered and the subdivision can be performed with high accuracy. Thus, the structure of the apparatus is simplified, with less wear and damage to the components, and with long mechanical service life and improved ease of cleaning and maintenance.

Also, according to the invention according to the second aspect of the present invention, the heat exchange unit is provided inside of the cylinder case such that the conduits of the heat exchange unit meanderingly extend concentrically in its cross section or such that the conduit spirally extend.

The heat is produced as the high-pressure compressed base material is passed through the orifice having the small clearance at high speed, and the dispersion, emulsification, crushing, and subdivision of the base material is performed with the high pressure difference. The heat is placed under heat exchange through the cooling medium passing through the continuous conduits over the desired length in the cylinder case in the length direction thereof, the orifice as the source of heat being center around which the conduits extend. The heat exchange is efficiently performed. the cylinder case and the orifice components such as the movable valve provided slidably inside of the cylinder case are prevented from being expanded due to thermal conduction caused by the heat produced by the orifice, by virtue of cooling effect by the cooling medium flowing through the conduits of the cooling device extending about the heat-source orifice as the central axis.

Accordingly, the small clearance of the orifice, which is defined between (a) the end of the movable valve provided inside of the cylinder case and (b) the opposing wall surface of the cylinder case, can be maintained in an appropriate degree. The base material can be efficiently subdivided. The operation can be more accurately performed. The base material can be passed thorough the orifice without the orifice getting clogged with the base material. The subdivision of the base material is not hindered and the subdivision can be performed with high accuracy. Thus, the structure of the apparatus is simplified, with less wear and damage to the components, and with long mechanical service life and improved ease of cleaning and maintenance.

Also, according to the third aspect of the present invention, the heat exchange unit meanderingly extends in an exterior body attached to an external surface of the cylinder case and cross-sectionally concentrically or spirally. The heat is produced as the high-pressure compressed base material is passed through the orifice having the small clearance at a high speed, and the dispersion, emulsification, crushing, and subdivision of the base material is performed with the high pressure difference. The heat is placed under heat exchange through the cooling medium passing through the continuous conduits over a desired length in the cylinder case in the length direction thereof, the orifice as the source of heat being center around which the conduits extend. The heat exchange is efficiently performed. the cylinder case and the orifice components such as the movable valve provided slidably inside of the cylinder case are prevented from being expanded due to thermal conduction caused by the heat produced by the orifice, by virtue of cooling by the cooling medium flowing through the conduits of the cooling device extending about the heat-source orifice as the central axis. Accordingly, the small clearance of the orifice, which is defined between (a) the end of the movable valve provided inside of the cylinder case and (b) the opposing wall surface of the cylinder case, can be maintained in an appropriate degree. The base material can be efficiently subdivided. The operation can be more accurately performed. The base material can be passed thorough the orifice without the orifice getting clogged with the base material. The subdivision of the base material is not hindered and the subdivision can be performed with high accuracy. Thus, the structure is simplified, with less wear and damage to the components, and with long mechanical service life and improved ease of cleaning and maintenance.

Also, according to the fourth aspect of the present invention, the heat exchange unit is either provided in the at least one cylinder block body out of cylinder block bodies constituting the cylinder case, the at least one block body being carried by the internal pressure adjustment valve installation section within which the orifice is defined, or provided in the exterior body attached to the external surface of the cylinder block body.

The heat is placed under heat exchange through the cooling medium passing through the continuous conduits over the desired length in the cylinder case in the length direction thereof, the orifice as the source of heat being center around which the conduits extend. The heat exchange is efficiently performed. the cylinder case and the orifice components such as the movable valve provided slidably inside of the cylinder case are prevented from being expanded due to thermal conduction caused by the heat produced by the orifice, by virtue of cooling by the cooling medium flowing through the conduits of the cooling device extending about the heat-source orifice as the central axis. Accordingly, the small clearance of the orifice, which is defined between (a) the end of the movable valve provided inside of the cylinder case and (b) the opposing wall surface of the cylinder case, can be maintained in an appropriate degree. The base material can be efficiently subdivided. The base material can be passed thorough the orifice without the orifice getting clogged with the base material. The subdivision of the base material is not hindered and the subdivision can be performed with high accuracy. Thus, the structure of the apparatus is simplified, with less wear and damage to the components, and with long mechanical service life and improved ease of cleaning and maintenance.

Also, according to the fifth aspect of the present invention, the cooling medium is selected from tap water, oil, gas, cooled tap water, cooled oil, or cooled gas. The heat is placed under heat exchange through the cooling medium passing through the continuous conduits over the desired length in the cylinder case in the length direction thereof, the orifice as the source of heat being center around which the conduits extend. The heat exchange is efficiently performed. the cylinder case and the orifice components such as the movable valve provided slidably inside of the cylinder case are prevented from being expanded due to thermal conduction caused by the heat produced by the orifice, by virtue of cooling by the cooling medium flowing through the conduits of the cooling device extending about the heat-source orifice as the central axis. Accordingly, the small clearance of the orifice, which is defined between (a) the end of the movable valve provided inside of the cylinder case and (b) the opposing wall surface of the cylinder case, can be maintained in an appropriate degree. The base material can be efficiently subdivided. The treatment of the base material can be more accurately performed. The base material can be passed thorough the orifice without the orifice getting clogged with the base material. The subdivision of the base material is not hindered and the subdivision can be performed with high accuracy. Also, the cooling medium is readily available. Tap water as the cooling medium is readily available and inexpensive with ease and efficiency of handling.

Also, according to the sixth aspect of the present invention, the cooling medium flows into the meandering conduit from the lower side of the cylinder case, is passed through the meandering conduits toward the upper side of the cylinder case, and then is exited from the meandering conduit. The cooling medium flows slowly through the conduits as opposed to the orifice as the source of heat having the small clearance, and sufficient period of time for heat exchange and efficient heat exchange is provided.

Also, according to the seventh aspect of the present invention, the orifice has the small clearance between 1/100 millimeters and 1/200 millimeters. The small clearance between 1/100 millimeters and 1/200 millimeters is ensured appropriately, the orifice being defined between the end of the movable valve provided slidably and rotatably inside of the cylinder case and the opposing wall surface of the cylinder case. The base material can be efficiently subdivided. The treatment of the base material can be more accurately performed; the base material can be passed thorough the orifice without the orifice getting clogged with the base material. The subdivision of the base material is not hindered and the subdivision can be performed with high accuracy.

Also, according to the eighth aspect of the present invention, in any of the first to seventh aspects of the present invention, the suspension containing the base material or the base material in the form of the semifluid matter is compressed with the high pressure from 100 MPa to 280 MPa. The base material is passed through the orifice having the small clearance. Dispersion, emulsification, crushing, and subdivision of the base material are performed with the high pressure difference.

### BRIEF DESCRIPTION OF THE DRAWINGS

In the drawings:

FIG. 1 is a cross-sectional view of a cooling device in its full view of a high pressure homogenizing apparatus according to a first embodiment of the present invention.

FIG. 2 is a vertical cross-sectional view of the cooling device of the high pressure homogenizing apparatus according to the first embodiment of the present invention.

FIG. 3 is a transverse cross-sectional view of the same cooling device.

FIG. 4 is an enlarged transverse cross-sectional view of the cooling device of the high pressure homogenizing apparatus according to a second embodiment of the present invention

### DESCRIPTION OF EXEMPLARY EMBODIMENTS

The following describes the exemplary embodiments of the present invention with reference to the drawings.

### First Embodiment

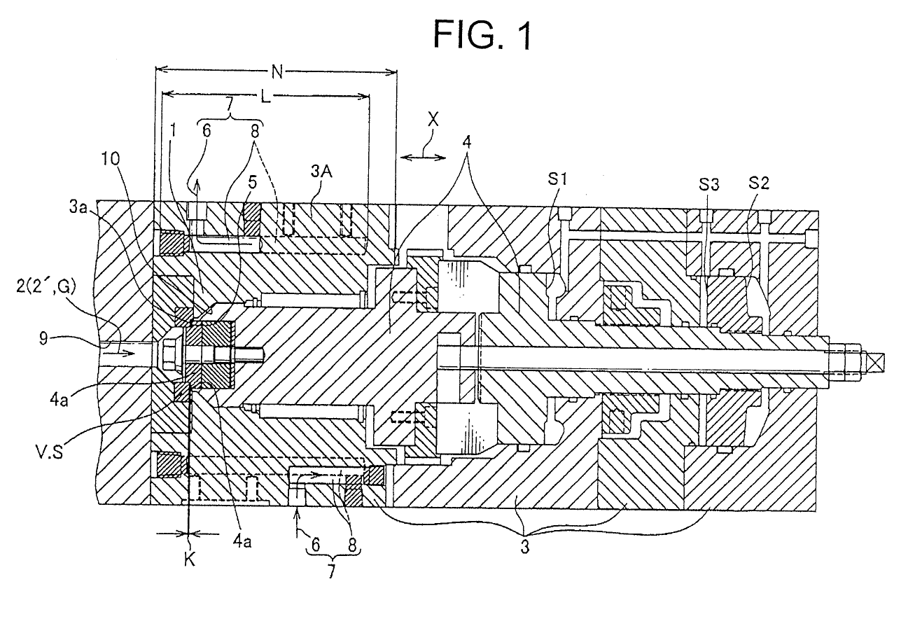

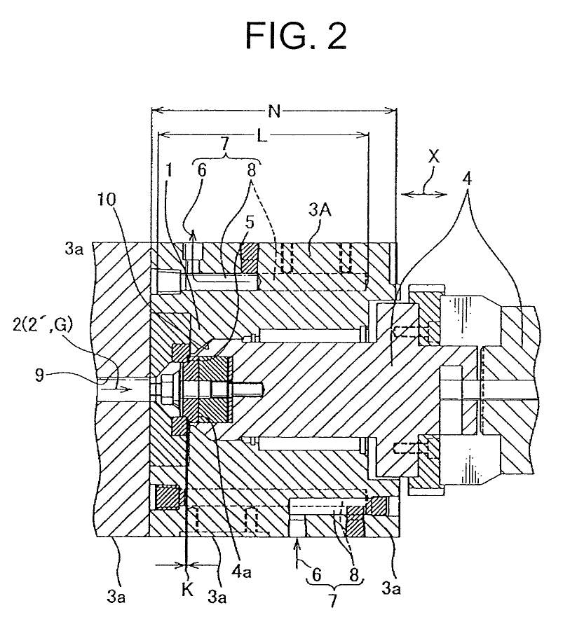

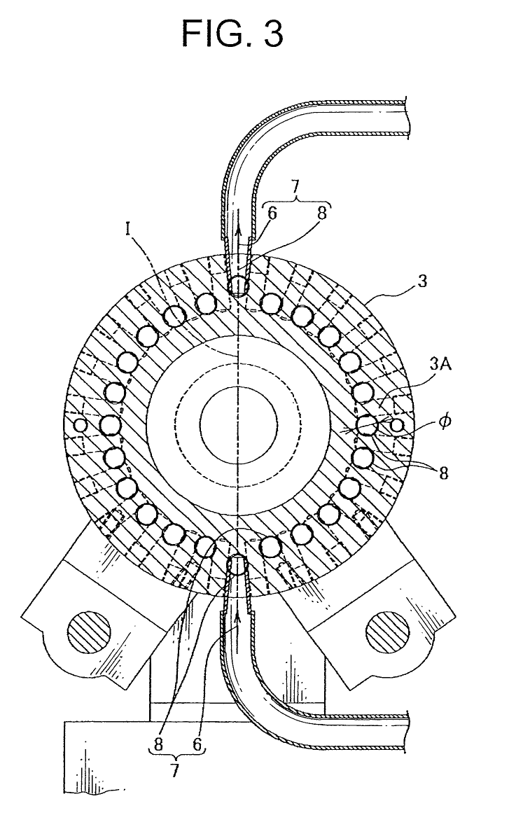

FIG. 1 is a cross-sectional view of a cooling device in its full view of a high pressure homogenizing apparatus according to a first embodiment of the present invention. FIG. 2 is a vertical cross-sectional view of the cooling device of the high pressure homogenizing apparatus according to the first embodiment of the present invention. FIG. 3 is a transverse cross-sectional view of the same cooling device.

A cooling device according to the first embodiment is for use in a high pressure homogenizing apparatus 1 constructed to compress a suspension 2 containing a base material G under high pressure, and let the compressed base material G pass through an orifice 5 at high speed.

The base material G includes a fine solid matter, a fiber cellulose, and a cell. The base material G may be in the form of a semifluid matter 2′. The orifice is defined by a small clearance between an end 4a of a movable valve 4 and an opposing wall surface of the cylinder case 3, the movable valve 4 being slidable and rotatable inside of the cylinder case 3 in a length direction X thereof. Dispersion, emulsification, crushing, and subdivision of the base material G is performed with a high pressure difference. The cooling device of the first embodiment is characterized by the fact that it includes a heat exchange unit 7 that includes a set of conduits 8 via which a cooling medium 6 can flow through the cylinder case 3, and that the heat exchange unit 7 extends over a desired length L in the length direction X of the cylinder case 3 and radially of the orifice 5 as a source of heat, the orifice being a center.

The base material G may include the following:

In the food industry, (A) food materials containing starch, i.e., grains such as (i) brown rice in a form of a solid body for Mochi (Japanese rice cake) and Senbei (Japanese rice cracker); (ii) buckwheat for Soba (Japanese buckwheat noodles); (iii) wheat for bread dough, pie dough, and Udon (Japanese wheat noodles); (iv) soybeans for Tofu (pate do soja), soybean milk, seasonings, soy sauce, and Miso (fermented soybean paste); and (v) adzuki beans (red bean); (B) fruits and vegetables for jam, wine, juice, and vegetable oil; (C) milk for dairy products such as butter and yogurt; (D) tea leaves for black tea and green tea; (E) coffee beans for coffee, and (F) barley and hop for beer.

The base material may be a solid body as a source of nutrition for soup, baby food, emergency rations, a hospital diet, nourishing foods, and space foods.

The base material may be the suspension 2 or the semifluid matter 2′ of finished or half-finished goods containing preparations, fiber cellulose, solid body including preparation, fiber cellulose, and casein in terms of separation prevention, long-term stability, flavor, and richness, the solid body being contained in a finished or half-finished products.

With regard to the chemical products, cosmetics, and other manufactured products, the base material may be solid bodies such as pigment, magnetic powder, a mineral, carbon powder contained in the suspension 2, an emulsification liquid, or semifluid matter 2′ as a finished or half-finished product.

With regard to medical products, the base material may be the suspension 2, semifluid matter 2′ or an emulsification liquid containing minerals and herbal medicine as a finished or half-finished product. In the context of glass industry, fine solid matters such as pigment, minerals contained in a liquid glass.

In the areas of the synthetic resin industries, the base material may be contained in the suspension 2 or the semifluid matter 2′ or an emulsification liquid as semi-finished products and finished products, including a thermoplastic liquid medium and inorganic substance contained therein such as carbon, a mineral, a plasticizer, reinforcement fiber, ceramic.

In the areas of paper industry, the base material may be a solid matter of fiber cellulose contained in the suspension 2 or the semifluid matter 2′ during a manufacturing process.

In pathology laboratories, the base material may be the suspension 2 or the semifluid matter 2′ containing cells of fungi such as Escherichia coli and yeast.

In order that the movable valve 4 is slid in the length direction X, the movable valve 4 is constructed to receive a hydraulic pressure from a hydraulic pressure circuit at a first forward pressure receiving portion S1 and a second forward pressure receiving portion S2 provided at a rear portion of the movable valve 4 so as to move forward in the length direction X. Also, the movable valve is moved rearward by virtue of the hydraulic pressure received by a third pressure receiving portion S3. In this manner, the small clearance K of the orifice 5 is adjusted in response to a compression pressure for the base material G.

In order that the movable valve 4 is rotated about an axis at a desired time point or for every desired period of time specified by a timer unit, for example, a rotary drive force of a not-shown motor is transferred to the movable body 4 via a set of gears such as a driving gear and a driven gear and power transmission components such as a belt and a pulley, so that the movable valve 4 is rotated clockwise or counterclockwise. The reason for such rotation of the movable valve 4 is that clogging of the orifice 5 should be avoided as the high-viscosity suspension 2 and a base material G in the form of the semifluid matter 2′ are subdivided through the orifice 5.

Referring to FIGS. 1 and 2, the orifice 5 is provided with a small and narrow clearance K defined between (a) a wall surface 3a of the cylinder case 3 an end 4a of the movable valve 4 opposed to a valve seat VS provided on the wall surface 3a. The orifice 5 has the small clearance K from 1/100 millimeters up to 1/200 millimeters. The reason for making the small clearance of the orifice 5 in the range of 1/100 millimeters up to 1/200 millimeters is, in the course of the operation of dispersion, emulsification, crushing, and subdivision of the base material G, to compress the base material G with the high pressure, pass the base material G through the orifice 5 defined by the small clearance K at the high speed, to perform with the high pressure difference the dispersion, emulsification, crushing, and subdivision of the base material G without the orifice 5 clogged with the base material G to avoid inconvenience in subdivision of the base material G, and to perform the subdivision of the base material G with high accuracy.

Also, base material G contained in the suspension 2 is compressed by a high pressure of 100 megapascals (MPa) up to 280 MPa, and is passed through the orifice 5 having the small clearance K at the high speed, so that the dispersion, emulsification, crushing, and subdivision of the base material G is performed with the high pressure difference. Also, a base-material-introducing passage 9 is provided on a first-order side (precedent stage) of the orifice 5, the passage 9 being constructed to introduce the high-compressed base material G into the cylinder case 3 and feed the material G to the orifice 5.

Also, a base-material-processing passage 10 is provided on a second-order side (the subsequent stage) of the orifice 5, the passage 10 being constructed to let the subdivided base material G flow, which is operable to be communicated with the base-material-introducing passage 9.

The heat exchange unit 7 of the first embodiment includes the conduits 8 in the cylinder case 3. More specifically, the conduits 8 are provided inside of at least the cylinder block body 3A out of a plurality of the cylinder block bodies obtained by dividing the cylinder case 3, the one being carried by an internal pressure adjustment valve installation section N within which the orifice 5 is defined, such that the conduits 8 meanderingly continuously extend in the length direction X and about the heat-source orifice 5 being the center, with the cross sections of the conduits 8 being concentrically distributed (see FIG. 3). In this respect, in the illustrated embodiment, the conduits 8 meanderingly provided inside of the cylinder block body 3A have the following features. An inlet is provided at a predetermined end in the radial direction thereof. In the illustrated example, the inlet is provided in a lower side. An outlet is provided at the other predetermined end in the radial direction (at an upper side in the illustrated example).

Also, the conduit 8, as becoming spaced from the inlet, branches cross-sectionally into a left branch and a right branch. The conduit 8 extends over a large part of the intermediate region between the inlet and the outlet concentrically in its cross section, and symmetrically with reference to the central axis line I of the cylinder block body 3A, meandering in the length direction X. Further, the conduit branches merge into the single conduit 8, the merger occurring proximate to the outlet. Nevertheless, although not shown and not limited to the illustrated configuration, the conduit 8 may be provided in a spiral manner.

In the first embodiment, the diameter φ (phi) of the conduit 8 is (but not limited to) 11.5 millimeters. The overall length of the meandering conduit 8 is (but not limited to) between 3100 and 3500 millimeters, which may be defined and modified as required.

Also, in the first embodiment, there is illustrated twenty-four conduits 8 (see FIG. 3) the number of conduits 8, and a diameter y of the conduits 8 is not limited to the shown example, and can be modified as required. The reason for this multiple-component configuration of the cylinder case 3 is that disassembling and reassembling of the cylinder case 3 is facilitated and thus the replacement and replenishment of the orifice 5 and other components, and cleaning of an internal space is also facilitated, so that the maintenance and management is facilitated.

The cooling medium 6 may be tap water, oil, gas, or any cooled one of these items. The cooling medium 6 of the first embodiment flows through the meandering conduit 8 from the lower side of the cylinder case 3 toward an inside of the conduit 8, further to the upper side of the cylinder case 3 and then to an outside thereof. The reason for making the cooling medium 6 flow through the conduit 8 from downward of the cylinder case 3 toward the inside of the conduit 8, and further upward of the cylinder case 3 and finally to the outside is that the cooling medium 6 is allowed to flow slowly through the conduit 8 for the orifice 5 as a source of heat having the small clearance K so that there is sufficient time for heat exchange to ensure efficient heat exchange. It is appreciated that the direction of the cooling medium 6 flowing through the conduit 8 is not limited to from-downward-to-upward manner as has been mentioned, but the direction may be in an upstream-to-downstream manner.

The foregoing described the construction and arrangement of the cooling device of the high pressure homogenizing apparatus 1 according to the first embodiment. Operation of dispersion, emulsification, crushing and/or subdivision of the fine base material G is described in the following.

The base material G contained in the suspension 2 or the base material in the form of the semifluid matter 2′ is compressed with the high pressure, for example, in the range of 100 to 280 megapascals (MPa). Further, the base material G is passed at the high speed through the orifice 5. The orifice 5 includes the small clearance K defined between (a) the end 4a of the movable valve 4 provided slidably and rotatably in the length direction X inside of the cylinder case 3 and (b) the opposing wall surface 3a of the cylinder case 3. By virtue of this configuration, the base material G is subjected to the dispersion, emulsification, crushing, and subdivision of the base material G with the high pressure difference.

A heat is generated as the high-pressure-compressed base material G is passed through the orifice 5 having the small clearance at the high speed, and the base material G is dispersed, emulsified, crushed, and/or subdivided under the high pressure difference. In the first embodiment, the heat exchange unit 7 includes the conduits 8 extending in the cylinder case 3, which should be described more specifically and consistently.

The conduits 8 is provided inside of at least the cylinder block body 3A out of a plurality of the cylinder block bodies obtained by dividing the cylinder case 3, the one being carried by the internal pressure adjustment valve installation section N within which the orifice 5 is defined, such that the conduits 8 meanderingly continuously extend in the length direction X and about the heat-source orifice 5 being the center. The coaxial cross sections of the conduits 8 are shown in FIG. 3. By virtue of this, the cooling medium 6 which may be the tap water, oil, gas, or any cooled one of these items cooled by the not-shown cooling device flows through the meandering conduits 8 from the lower side of the cylinder case 3 to the inside of the conduit 8, and further to the upper side of the cylinder case 3 and finally to the outside thereof. As a result, the heat generated when the base material G contained in the suspension 2 or in the foam of the semifluid matter is passed through the orifice 5 at the high speed is placed under heat exchange over the desired length from radially outward by the cooling medium 6 of the heat exchange unit 7 and thus cooled. It should be noted that the illustrated example does not include a heat-release fin in the cylinder block 3A. Nevertheless, since the illustrated one is an example, it is possible to provide a heat-release fin for cooling operation.

In this respect, in the cooling medium 6 of the illustrated first embodiment flows into the conduit 8 via the inlet at the lower side of the cylinder case 3, and flows upward of the cylinder case 3 and is exited from the conduit 8 via an outlet provided on an upper portion to the outside. Accordingly, the cooling medium 6 is allowed to flow slowly through the conduits 8 with respect to the heat-source orifice 5 having the small clearance K at the central portion so that sufficient heat exchange time is ensured and the orifice 5 is placed under efficient heat exchange.

The conduits 8 of the cooling device 7 shown in FIG. 3 are substantially equiangularly and concentrically provided inside of the cylinder block body 3A. Accordingly, when the cooling medium 8 is passed through the conduits 8 during cooling by the cooling device 7, the cylinder block body 3A and the orifice components such as the movable valve 4 slidably and rotatably disposed inside of the cylinder case 3 can be uniformly and evenly cooled. Furthermore, when the subdivision of the base material G is performed and the heat-source orifice 5 produces the heat, the cylinder block body 3A and other orifice components share uniform and average degree of elongation in the length direction X and the radial direction. Furthermore, in a structural context, since the conduits 8 extend concentrically, a stress is evenly distributed without concentration to a single region and the structure becomes robust.

Also, as has been described in the foregoing, since the conduits 8 meanderingly continuously extend in the length direction X with the cross sections of the conduits 8 being concentrically distributed in the cylinder block body 3A (see FIG. 3), for example, in contrast to meandering pipes extending on an external surface of the cylinder block body 3A, in crease of an overall diameter is avoided, allowing compact configuration and installation of the cooling device 7, eliminating complicated and crude external appearance. Further, it is not necessary to provide the meandering pipe on the external surface of the cylinder block body 3A with interfaces of the pipes welded onto the external surface, so that favorable property of construction and workmanship becomes available and manufacturing will be considerably facilitated.

Accordingly, in dispersion, emulsification, crushing, and subdivision of the base material the cylinder case 3 and the orifice components such as the movable valve 4 provided slidably inside of the cylinder case 3 are prevented from being expanded due to thermal conduction caused by the heat produced by the orifice 5, by virtue of cooling by the cooling medium 6 flowing through the conduits 8 of the cooling device 7. The small clearance K of the orifice 5, which is defined between (a) the end 4a of the movable valve 4 provided slidably and rotatably in the length direction X inside of the cylinder case 3 and (b) the opposing wall surface 3a of the cylinder case 3, is prevented from becoming decreased due to thermal expansion of the cylinder case, so that the small clearance K of the orifice 5 can be specified as a small clearance K from 1/100 up to 1/200 millimeters. This allows the base material G to be passed through the orifice 5 without the orifice 5 getting clogged with the base material G It is possible to perform subdivision of the base material G with a high accuracy.

In fact, a slip of paper having a water content ratio of about 8 percentages by weight is finely cut by a cutting machine (type NS-32C of Nakabayashi Co., Ltd) in order of 4×15 millimeters, and about 43.5 grams of the obtained fine pieces is added to about 956.5 grams of water.

Thereafter, the water containing the fine pieces is stirred by a blender (type MX-152S of Matsushita Electric Industry) for one minute, so that the solid matter of the fiber cellulose is finely crushed to some extent so as to be dispersed uniformly in the water. Four percentages by weight (wt) of the crushed solid matter (fiber cellulose) is used as the base material G The base material G is compressed under the high compression pressure of 200 MPa. The compressed base material G is passed through the orifice 5 at a high speed. In this manner, the crushing and subdivision of the base material G is performed with a high pressure difference. In this case, it is assumed, for example, that the orifice 5 experiences heating in the range of 40 to 45 degrees centigrade. The conduits 8 is provided inside of at least the cylinder block body 3A out of a plurality of the cylinder block bodies constituting the cylinder case 3, the one being carried by the internal pressure adjustment valve installation section N within which the orifice 5 is defined, such that the conduits 8 meanderingly continuously extend in the length direction X and about the heat-source orifice 5 being the center and cross-sectionally concentrically (see FIG. 3). Tap water in a temperature of 20 to 25 degrees centigrade as the cooling medium 6 flows through the above conduits 8 from a lower side of the cylinder case 3 and toward an upper side of the cylinder case 3, so that cooling by the cooling device 7 is performed. Even when the apparatus operates over an extended period of time, the small clearance K of the orifice 5 is appropriately kept to be a small clearance K from 1/100 millimeters up to 1/200 millimeters. The base material G does not experience clogging within the orifice 5. The base material G is allowed to pass through the orifice 5. It has been found that the it is possible to perform subdivision of the base material G with a high accuracy.

Also, the cylinder case 3, the movable valve 4 attached slidably inside of the cylinder case 3 and other orifice components are protected against being expanded due to the thermal conduction by virtue of cooling by the cooling medium 6 flowing through the conduits 8 of the cooling device 7. Accordingly, the structure is simplified, with less wear and damage to the components, and with long mechanical service life and improved ease of cleaning and maintenance.

### Second Embodiment

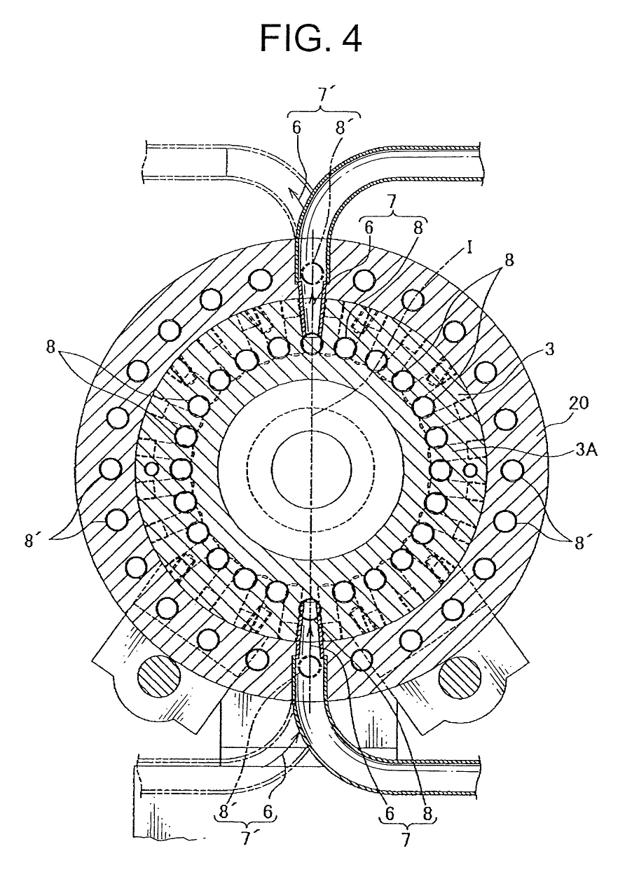

Referring to FIG. 4, there is shown the cooling device of the high pressure homogenizing apparatus according to a second embodiment of the present invention.

In the first embodiment, the heat exchange unit 7 is provided inside of at least the cylinder block body 3A out of a plurality of the cylinder block bodies constituting the cylinder case 3, the one being carried by the internal pressure adjustment valve installation section N within which the orifice 5 is defined. In the second embodiment 2, the heat exchange unit 7 includes the conduits 8 inside of the cylinder block body 3A as in the first embodiment, and further includes the conduits inside of the tubular exterior body 20 attached to an external surface of the cylinder block body 3A.

In the second embodiment 2, the high-pressure compressed suspension 2 or the high-pressure compressed base material G in the form of the semifluid matter 2′ compressed by the high pressure is passed through the orifice 5 at the high speed, the orifice 5 having the small clearance K defined between (a) the end 4a of the movable valve 4 provided slidably and rotatably inside of the cylinder case 3 and (b) the wall surface 3a of the cylinder case 3. Heat is produced in dispersion, emulsification, crushing, and subdivision of the base material G with the high pressure difference. In the second embodiment 2, the heat exchange units 7, 7′ include the conduits 8, 8′, respectively, which should be described more specifically and consistently. The conduits 8′ are provided inside of an exterior body 20 such that the conduits 8′ meanderingly and continuously extend in the length direction and about the heat-source orifice 5 which is the center of axis. Furthermore, the conduits 8, 8′ cross-sectionally concentrically extend as shown in FIG. 4.

The cooling medium 6 flows through the meandering conduits 8, 8′ from the lower side of the cylinder case 3, further to the upper side of the cylinder case 3, and finally to the outside thereof. The cooling medium 6 is selected from tap water, oil, gas, or any cooled one of these items tap water cooled by the not-shown cooling device. As a result, the heat generated when the base material G contained in the suspension 2 or in the form of the semifluid material is passed through the orifice 5 at the high speed is placed under heat exchange over the desired length L from radially outward by the cooling medium 6 of the heat exchange unit 7, 7′ in a duplex manner and is surroundedly cooled (duplex refers to configuration with the inner conduits and the outer conduits). The efficiency of cooling is more enhanced than in the first embodiment with respect to the heat produced by the orifice 5 in the course of subdivision of the base material G.

Accordingly, in dispersion, emulsification, crushing, and subdivision of the base material G, cylinder case 3 and the orifice components such as the movable valve 4 provided slidably inside of the cylinder case 3 are prevented from being expanded due to thermal conduction caused by the heat produced by the orifice 5, by virtue of cooling by the cooling medium 6 flowing through the inner and outer conduits 8, 8′ of the cooling devices 7, 7′. The advantage is more enhanced than in the first embodiment. The small clearance K of the orifice 5, which is defined between (a) the end 4a of the movable valve 4 provided slidably and rotatably in the length direction X inside of the cylinder case 3 and (b) the opposing wall surface 3a of the cylinder case 3, is prevented from becoming decreased due to thermal expansion of the cylinder case, so that the small clearance K of the orifice 5 can be specified as a small clearance K from 1/100 up to 1/200 millimeters. This allows the base material G to be passed through the orifice 5 without the orifice 5 getting clogged with the base material G and it is possible to perform subdivision of the base material G with higher accuracy. With regard to the other features, the second embodiment has the same construction and advantages as in the first embodiment.

In the above explanation, the conduits 8, 8′ of the cylinder block body 3A and the exterior body attached to the external surface of the cylinder block body 3A, the conduits 8, 8′ constituting the heat exchange unit 7, 7′, are configured to meander about the heat-source orifice 5 as the center. This configuration is typical and exemplary. The conduits 8, 8′ may extend in a spiral fashion clockwise or counterclockwise so as to pass the cooling medium 6, 6′ therethrough so that the heat-source orifice 5 is cooled. This also belongs to the scope of application of the present invention.

### INDUSTRIAL APPLICABILITY

The present invention is capable of ensuring appropriately-defined small clearance of the orifice, avoiding inadvertent leakage of the base material and clogging of the orifice with the base material, and performing treatment and subdivision of the base material with high accuracy. Also, the present invention has a simple structure with less wear and damage to tits components, with long mechanical service life and improved ease of cleaning and maintenance.

### REFERENCE SIGNS

1 High pressure homogenizing apparatus
2 Suspension
2′ Semifluid matter
3 Cylinder case
3A Cylinder block body
3a Wall surface
4 Movable valve
4a End
5 Orifice
6 Cooling medium
7 Heat exchange unit
7′ Heat exchange unit
8 Passage
8′ Passage
20 Exterior body
G Base material
X Length direction

1-8. (canceled)

9. A high pressure homogenizing apparatus having a cooling device, constructed to compress with a high pressure a suspension containing a fine base material or the base material in a form of a semifluid matter for dispersion, emulsification, crushing, and subdivision of the base material with a high pressure difference, the apparatus comprising:
(a) a cylinder case;
(b) a movable valve operable to be rotated in the cylinder case and slid in a length direction of the cylinder case;
(c) an orifice including a small clearance defined between an end of the movable valve and an opposing wall surface of the cylinder case, the compressed base material being passed through the orifice at a high speed; and
(d) a heat exchange unit provided in the cylinder case, the heat exchange unit including conduits continuously extending in the cylinder case over a desired length in the length direction of the cylinder case, the conduits being constructed to let a cooling medium flow therethrough, and the conduits extending radially of the orifice such that the orifice as a source of heat is surrounded by the conduits in the length direction of the cylinder case.

10. The high pressure homogenizing apparatus having the cooling device as set forth in claim 9, wherein the conduits of the heat exchange unit either meanderingly extend concentrically with each other when viewed in cross sections thereof or extend spirally inside of the cylinder case.

11. The high pressure homogenizing apparatus having the cooling device as set forth in claim 10, wherein the heat exchange unit is either provided in a portion of at least one cylinder block body from among a plurality of cylinder block bodies constituting the cylinder case, the portion of the at least one cylinder block body corresponding to an internal-pressure-adjustment-valve installation section within which the orifice is provided.

12. The high pressure homogenizing apparatus having the cooling device as set forth in claim 11, further comprising the conduits of the heat exchange unit extending in an exterior body attached to an external surface of the cylinder case, the conduits meanderingly extending concentrically with each other when viewed in cross sections thereof or spirally in the exterior body.

13. The high pressure homogenizing apparatus having the cooling device as set forth in claim 12, wherein the cooling medium is selected from tap water, oil, gas, cooled tap water, cooled oil, or cooled gas.

14. The high pressure homogenizing apparatus having the cooling device as set forth in claim 13, wherein the cooling medium is allowed to flow into the meandering conduits from a lower side of the cylinder case, to be passed through the meandering conduits toward an upper side of the cylinder case, and then to be exited from the meandering conduit.

15. The high pressure homogenizing apparatus having the cooling device as set forth in claim 14, wherein the orifice has a small clearance between 1/100 millimeters and 1/200 millimeters.

16. The high pressure homogenizing apparatus having the cooling device as set forth in claim 15, wherein the suspension or the base material in the form of the semifluid matter is adjusted so as to have an internal pressure from 100 MPa to 250 MPa.
